(19) United States
(12) Patent Application Publication
(10) Pub. No.: US 2008/0170047 A1
(43) Pub. Date: Jul. 17, 2008

(54) Liquid crystal display device

(76) Inventor: Tsutomu Sato, Mobara (JP)

Correspondence Address: REED SMITH LLP, Suite 1400, 3110 Fairview Park Drive, Falls Church, VA, 22042, US

(21) Appl. No.: 12/007,092

(22) Filed: Jan. 7, 2008

(30) Foreign Application Priority Data
Jan. 15, 2007 (JP) 2007-005428

(51) Int. Cl. G06F 3/042; G09G 3/36

(52) U.S. Cl. 345/175; 345/102

(57) ABSTRACT

In a liquid crystal display device having a liquid crystal display panel, the liquid crystal display panel includes a display section having a plurality of pixels disposed therein and a peripheral section disposed so as to surround the display section. A display corresponding to a touch key is displayed on the display section at a boundary portion between the display section of the liquid crystal display panel and the peripheral section adjoining thereto. A photosensor for detecting light is disposed at a portion in the peripheral section near the display corresponding to the touch key.

In this liquid crystal display device, the photosensor produces an output of a current value detected as a result of all or part of external light being shielded when a viewer touches the display corresponding to the touch key on the display section.

### CLAIM OF PRIORITY

The present application claims priority from Japanese Application JP 2007-005428 filed on Jan. 15, 2007, the content of which is hereby incorporated by reference into this application.

### BACKGROUND OF THE INVENTION

1. Field of the Invention

The present invention relates in general to liquid crystal display devices and, more particularly, to a technique that is effective when applied to a liquid crystal display device having a photosensor built into a liquid crystal display panel.

2. Description of Related Art

Liquid crystal display devices are rarely used in total darkness with no external light. The liquid crystal display devices are normally used with a liquid crystal display panel irradiated with external light of some sort, e.g., natural light or light from an interior illumination. JP-A-2003-21821 discloses a technique, by which ambient brightness of the liquid crystal display panel (specifically, external light illuminance) is measured to control luminance of a backlight.

The technique described in JP-A-2003-21821 involves increasing the luminance of the backlight for easier viewing in a bright ambience and decreasing the luminance of the backlight in a dark ambience to reduce power consumption, in which the liquid crystal display panel can be comfortably viewed.

JP-A-2003-21821 describes a liquid crystal display device including a photosensor as a discrete component. A known liquid crystal display device for mobile phones, on the other hand, includes a liquid crystal display panel having therein a photosensor.

Recent widespread use of mobile devices, on the other hand, attaches more importance to touch panel technology that supports “user-friendly” graphical user interfaces.

A capacitive touch panel, for example, is known as an example of the touch panel technology. Typically, the capacitive touch panel includes a touch panel substrate that is a glass substrate coated with a conductive coating (transparent conductive film) on a front surface (and a back surface) thereof. A user touches the touch panel substrate with his or her finger, so that a specific position touched by the finger in the panel is detected.

Such a touch panel substrate is mounted on a surface of a liquid crystal display panel to make a known touch panel-mounted liquid crystal display panel. The touch panel-mounted liquid crystal display panel allows a menu-driven operation to be performed by touching a menu screen displayed on the liquid crystal display panel with a finger (see non-patent document 1, S. Miyamoto et al., “High transmissivity capacitive touch screen”, Sharp Technical Bulletin, Vol. 92, pp. 59-63 (August 2005)).

### SUMMARY OF THE INVENTION

In the touch panel-mounted liquid crystal display panel described in the non-patent document 1, the touch panel substrate is mounted on the surface of the liquid crystal display panel. This arrangement poses a problem in that there is a reduction in light transmissivity by about 15%.

Another problem is that the touch panel substrate and related parts required as separate parts lead to increased cost.

The inventor focuses his attention on the photosensor for controlling the luminance of the backlight to make the present invention.

An object of the present invention is to provide a liquid crystal display device having a touch function, offering outstanding low cost performance without allowing light transmissivity to be reduced.

The foregoing and other objects, features and advantages of the present invention will be apparent from the following more particular description of the preferred embodiment of the present invention as illustrated in the drawings.

A brief summary of typical aspects of the present invention disclosed in the application concerned will be given below.

In accordance with a first aspect of the present invention, there is provided a liquid crystal display device having a liquid crystal display panel, the liquid crystal display panel comprising a first substrate, a second substrate, and a liquid crystal layer sandwiched between the first substrate and the second substrate. In this liquid crystal display device, the liquid crystal display panel includes a display section having a plurality of pixels disposed therein and a peripheral section disposed so as to surround the display section. A display corresponding to a touch key is displayed on the display section at a boundary portion between the display section of the liquid crystal display panel and the peripheral section adjoining thereto. Further, a photosensor for detecting light is disposed at a portion in the peripheral section near the display corresponding to the touch key.

In the liquid crystal display device according to the first aspect of the present invention, the photosensor produces an output of a current value detected as a result of all or part of external light being shielded when a viewer touches the display corresponding to the touch key on the display section.

To state it from a different viewpoint, in the liquid crystal display device according to the first aspect of the present invention, the liquid crystal display device determines, with the photosensor, that the display corresponding to the touch key on the display section is touched when the viewer touches the display corresponding to the touch key on the display section.

Further, in the liquid crystal display device according to the first aspect of the present invention, there are displayed on the display section displays corresponding to a plurality of touch keys, and a plurality of photosensors for detecting light is disposed at locations near the displays corresponding to the plurality of touch keys.

Further, in the liquid crystal display device according to the first aspect of the present invention, each of the plurality of photosensors compares a current value detected as a result of all or part of external light being shielded when a viewer touches any of the displays corresponding to the plurality of the touch keys displayed on the display section against current values detected by other photosensors, thereby determining a specific display corresponding to a specific touch key is selected.

The liquid crystal display device according to the first aspect of the present invention further includes a backlight, and a luminance of the backlight is adjusted based on the output of the current value produced by the photosensor.

Further, in the liquid crystal display device according to the first aspect of the present invention, the first substrate includes a non-overlapping area, in which the first substrate does not overlap the second substrate, and a driving circuit controlling the liquid crystal display panel is mounted on the non-overlapping area of the first substrate. The driving circuit may include a single chip, or two or more chips.

Further, in the liquid crystal display device according to the first aspect of the present invention, each of the plurality of photosensors is composed of a plurality of thin film transistors connected in parallel with each other.

In accordance with a second aspect of the present invention, there is provided a liquid crystal display device having a liquid crystal display panel, the liquid crystal display panel comprising a first substrate and a second substrate smaller in size than the first substrate with a liquid crystal sandwiched between the first substrate and the second substrate. In the liquid crystal display device, a portion, on which the first substrate overlaps the second substrate, includes a display section and a peripheral section. A plurality of gate wires, and a plurality of signal wires disposed so as to intersect the plurality of gate wires by way of an insulating film, are disposed on the first substrate to form the display section. At a boundary portion between the display section and the peripheral section, a display corresponding to a touch key is displayed on the display section and a photosensor for detecting light is disposed on the peripheral section at a portion near the display corresponding to the touch key.

Further, in the liquid crystal display device according to the second aspect of the present invention, the photosensor produces an output of a current value detected as a result of all or part of external light being shielded when a viewer touches the display corresponding to the touch key on the display section.

Further, in the liquid crystal display device according to the second aspect of the present invention, displays corresponding to a plurality of touch keys are displayed on the display section, and a plurality of photosensors for detecting light is disposed at locations near the displays corresponding to the plurality of touch keys.

Further, in the liquid crystal display device according to the second aspect of the present invention, a driving circuit controlling the liquid crystal display panel is disposed on a portion of the first substrate, on which the first substrate does not overlap the second substrate. The displays corresponding to the plurality of touch keys are displayed on a portion of the display section opposite a side on which the driving circuit is disposed. The plurality of photosensors is disposed on the peripheral section of the portion of the display section opposite the side on which the driving circuit is disposed.

Further, in the liquid crystal display device according to the second aspect of the present invention, the plurality of gate wires, the plurality of signal wires, and the plurality of photosensors are connected to the driving circuit. When the liquid crystal display panel is viewed in a planar direction, wires connecting the plurality of photosensors to the driving circuit are disposed on an outside of wires connecting the plurality of gate wires or the plurality of signal wires to the driving circuit.

In accordance with a third aspect of the present invention, there is provided a liquid crystal display device having a liquid crystal display panel, the liquid crystal display panel comprising a first substrate and a second substrate smaller in size than the first substrate with a liquid crystal sandwiched between the first substrate and the second substrate. In the liquid crystal display device, a portion, on which the first substrate overlaps the second substrate, includes a display section and a peripheral section. A plurality of gate wires, and a plurality of signal wires disposed so as to intersect the plurality of gate wires by way of an insulating film, are disposed on the first substrate to form the display section. A pixel is formed so as to be associated with an area surrounded by each of the plurality of gate wires and the plurality of signal wires, each pixel including a first thin film transistor switching each pixel and a pixel electrode connected to the first thin film transistor. At a boundary portion between the display section and the peripheral section, a display corresponding to a touch key is displayed on the display section and a photosensor for detecting light is disposed on the peripheral section at a portion near the display corresponding to the touch key. The photosensor includes a second thin film transistor.

Further, in the liquid crystal display device according to the third aspect of the present invention, the first thin film transistor includes a semiconductor layer formed of a p-Si layer and the second thin film transistor includes a semiconductor layer having a concavely shaped cross section, the concavely shaped semiconductor layer including a thin layer portion formed of a p-Si layer.

Further, in the liquid crystal display device according to the third aspect of the present invention, the concavely shaped semiconductor layer forming the second thin film transistor includes a thick layer portion having a thickness ranging between 180 nm and 220 nm and the thin layer portion having a thickness ranging between 45 nm and 55 nm.

Further, in the liquid crystal display device according to the third aspect of the present invention, the semiconductor layer forming the first thin film transistor has a thickness ranging between 45 nm and 55 nm.

Further, in the liquid crystal display device according to the third aspect of the present invention, the second thin film transistor includes a source electrode and a drain electrode, both being connected to the thick layer portion of the concavely shaped semiconductor layer.

Effects achieved by the typical aspects of the present invention disclosed in the application concerned will be as follows.

Specifically, according to the aspects of the present invention, it is possible to provide a liquid crystal display device having a touch function, offering outstanding low cost performance without allowing light transmissivity to be reduced.

### BRIEF DESCRIPTION OF THE DRAWINGS

The present invention will be described hereinafter with reference to the accompanying drawings.

FIG. 1 is a plan view showing schematically a liquid crystal display module according to an embodiment of the present invention.

FIG. 2 is a view showing a cross-sectional structure of an example of a photosensor shown in FIG. 1.

FIG. 3 is a circuit diagram showing an equivalent circuit of the photosensor shown in FIG. 1.

FIG. 4 is a view for illustrating a subpixel of a liquid crystal display panel shown in FIG. 1.

FIG. 5A is a flowchart showing typical procedures for position detection when a viewer's finger touches a display section of a liquid crystal display panel 1 according to the embodiment of the present invention and adjusting the luminance of a backlight of the same.

FIG. 5B is a flowchart showing typical procedures for position detection when the viewer's finger touches the display section of the liquid crystal display panel 1 according to the embodiment of the present invention and adjusting the luminance of the backlight of the same.

FIG. 6 is a view showing an example of a condition, in which the viewer touches the display section of the liquid crystal display panel with his or her finger in the liquid crystal display module according to the embodiment of the present invention.

FIG. 7 is a view showing another example of the condition, in which the viewer touches the display section of the liquid crystal display panel with his or her finger in the liquid crystal display module according to the embodiment of the present invention.

FIG. 8 is a view showing another example of the condition, in which the viewer touches the display section of the liquid crystal display panel with his or her finger in a liquid crystal display module according to a modified example of the embodiment of the present invention.

FIG. 9 is a view showing a condition of the display section and a peripheral section disposed on a TFT substrate.

FIG. 10A is a view showing a cross-sectional structure of a pixel transistor in the display section.

FIG. 10B is a view showing a cross-sectional structure of a photosensor in the peripheral section.

FIG. 11 is a graph indicating wavelength vs. sensitivity characteristics of the semiconductor layer.

FIG. 12A is a view showing a first manufacturing process.

FIG. 12B is a view showing a second manufacturing process.

FIG. 12C is a view showing a third manufacturing process.

FIG. 12D is a view showing a fourth manufacturing process.

FIG. 12E is a view showing a fifth manufacturing process.

FIG. 12F is a view showing a sixth manufacturing process.

### DETAILED DESCRIPTION OF THE PREFERRED EMBODIMENTS

A preferred embodiment according to the present invention will be described in detail below with reference to the accompanying drawings. In all drawings given for describing the embodiment of the present invention, like reference numerals refer to like parts and repeated descriptions are omitted.

A liquid crystal display module (liquid crystal display device) according to the embodiment of the present invention is a TFT system module including a compact liquid crystal display panel of about 240×320×3 pixels, capable of color display. The module is used as displays of portable devices, such as mobile phones. Not to mention, the present invention is applicable to any size of the liquid crystal display panel.

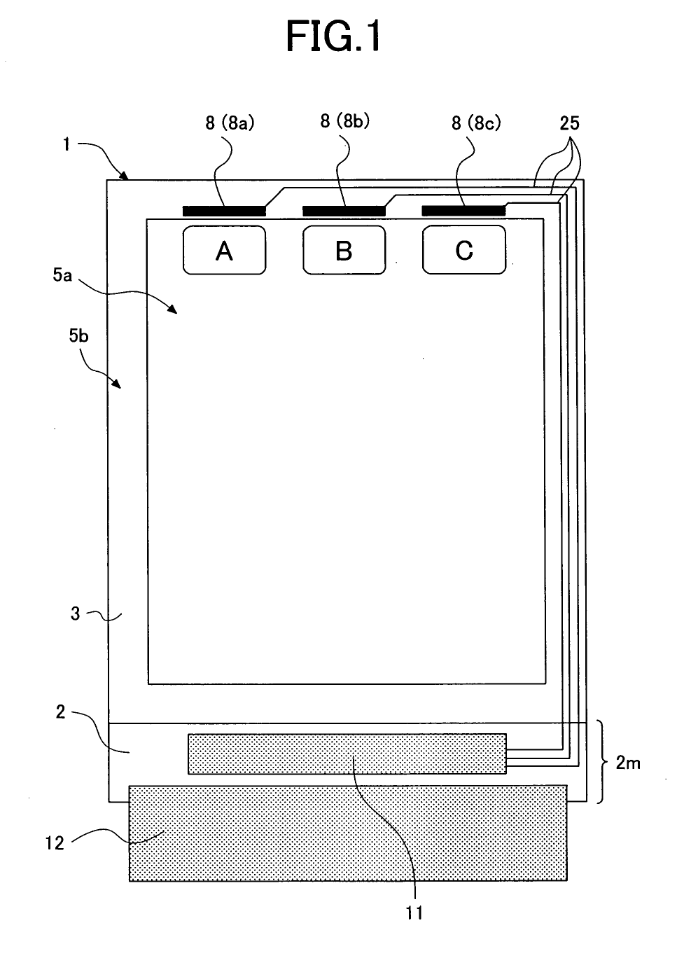

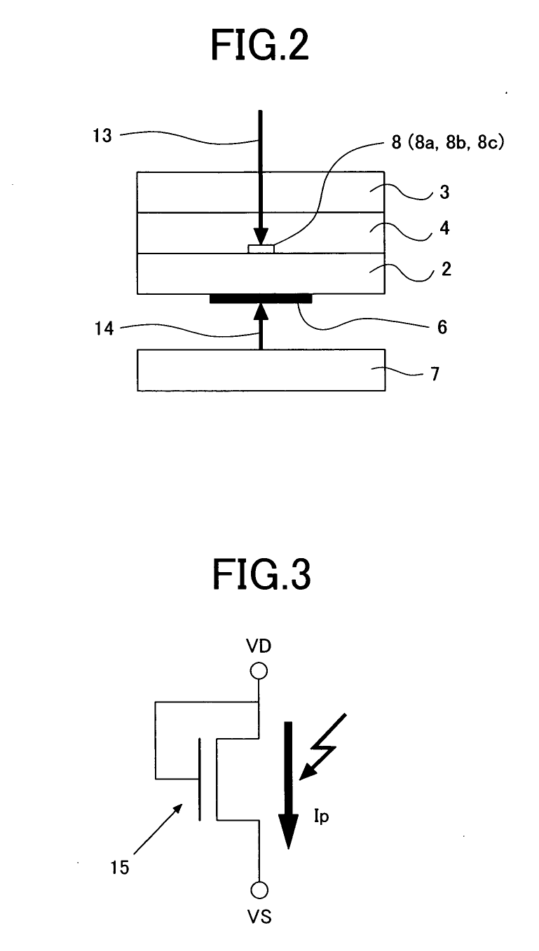

FIG. 1 is a plan view showing schematically the liquid crystal display module according to the embodiment of the present invention. FIG. 2 is a view showing a cross-sectional structure of an example of a photosensor shown in FIG. 1.

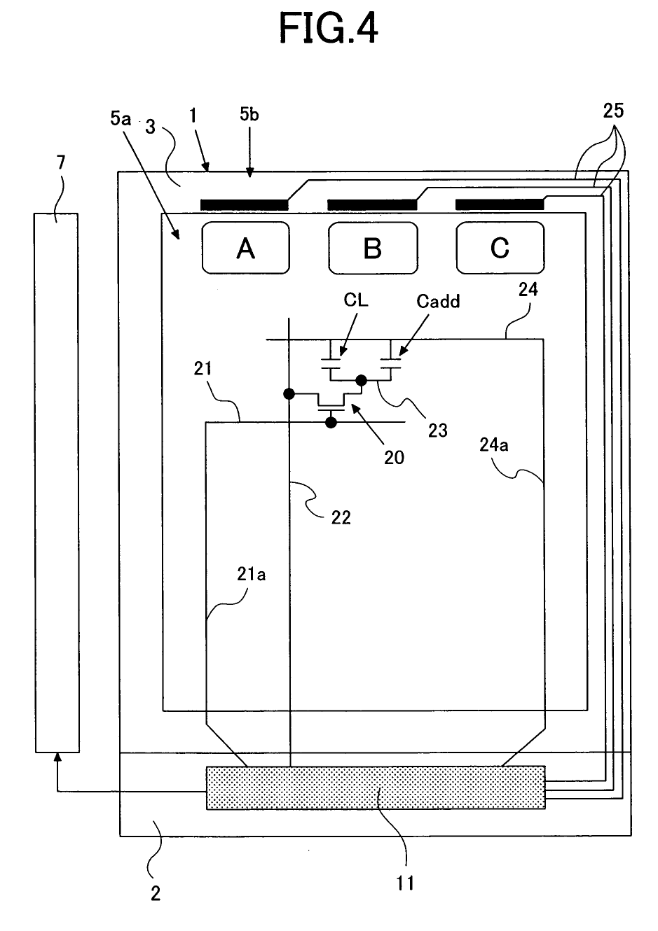

FIG. 4 is a view for illustrating a subpixel of a liquid crystal display panel 1 shown in FIG. 1.

Referring to FIGS. 1, 2, and 4, the liquid crystal display module according to the embodiment of the present invention includes the liquid crystal display panel 1, a backlight 7, a semiconductor chip 11, and a flexible wiring substrate 12.

Referring to FIG. 2, the liquid crystal display panel 1 includes a first substrate 2, a second substrate 3, and a liquid crystal layer 4 sandwiched between the first substrate 2 and the second substrate 3. A pixel electrode, a thin film transistor, and the like are formed on the first substrate 2 (also called a TFT substrate). A color filter and the like are formed on the second substrate 3 (also called a CG substrate or an opposed substrate). A main surface side of the second substrate 3 constitutes a view side.

Referring to FIG. 1, the liquid crystal display panel 1 includes a display section 5a and a peripheral section 5b disposed so as to surround the display section 5a. A plurality of subpixels is disposed in a matrix form on the display section 5a of the liquid crystal display panel 1.

Each of the plurality of subpixels includes a thin film transistor (TFT) 20 as shown in FIG. 4.

Referring to FIG. 4, reference numeral 23 denotes a pixel electrode, reference numeral 24 denotes a counter electrode (common electrode), reference character CL denotes liquid crystal capacity equivalently indicating a liquid crystal layer, and Cadd denotes holding capacity formed between the pixel electrode 23 and the counter electrode 24.

A gate electrode of the thin film transistor 20 in a row direction is connected to a scanning line 21. A drain electrode of the thin film transistor 20 in a column direction is connected to an image line 22. A source electrode of the thin film transistor 20 is connected to the pixel electrode 23.

Each of the scanning line 21, the image line 22, and the counter electrode 24 is connected to the semiconductor chip 11 that constitutes a driving circuit. In this case, the scanning line 21 is connected via a first wire 21a and the counter electrode 24 is connected via a second wire 24a to the semiconductor chip 11 constituting the driving circuit.

The liquid crystal display panel 1 is formed as follows. Specifically, the first substrate 2 and the second substrate 3 are placed one on top of the other at a predetermined spacing provided therebetween. The first and second substrates 2, 3 are then laminated together with a sealing material disposed in a frame-like form near peripheral edges of the two substrates. A liquid crystal is then injected inside the sealing material for the two substrates through a liquid crystal injection opening made in part of the sealing material. The liquid crystal is then encapsulated before a polarizing plate is affixed to an outside of the two substrates.

Glass is not the only material used for the first substrate 2 and the second substrate 3. Any other material, such as plastic, may be used as long as the material has an insulation property.

The counter electrode 24 is disposed on the side of the CF substrate (second substrate 3) if the liquid crystal display panel is of a TN or VA type. The counter electrode 24 is disposed on the side of the TFT substrate (first substrate 2) if the liquid crystal display panel is an IPS type.

In the liquid crystal display panel 1, each of the first substrate 2 and the second substrate 3 has a rectangular flat surface having a long side and a short side as shown in FIG. 1. The first substrate 2 has a long side longer than a long side of the second substrate 3. The first substrate 2 includes an area 2 m that does not overlap the second substrate 3 (hereinafter referred to as non-overlapping area).

The semiconductor chip 11 is mounted on the non-overlapping area 2 m of the first substrate 2. The flexible wiring substrate 12 has a first end connected electrically and mechanically to the non-overlapping area 2 m of the first substrate 2.

The semiconductor chip 11 has a circuit achieving a touch sensor function (means 1 of the present invention) and a circuit achieving a luminance adjustment function for the backlight 7 (means 2 of the present invention), in addition to a circuit for controlling and driving each subpixel.

Referring to FIG. 1, a plurality of photosensors 8 is disposed on the peripheral'section 5b of the liquid crystal display panel 1. In accordance with the embodiment of the present invention, three photosensors 8 (8a, 8b, 8c) are disposed on a side opposite the non-overlapping area 2 m of the first substrate 2.

FIG. 3 is a circuit diagram showing an equivalent circuit of the photosensors 8 shown in FIG. 1.

The three photosensors 8 (8a, 8b, 8c) are parasitic photodiodes of a thin film transistor 15 shown in FIG. 3. A photocurrent (ip) flows across a source and a drain of the thin film transistor 15 according to the illuminance of external light. Each of the photosensors 8 (8a, 8b, 8c) is configured so as to connect a plurality of thin film transistors 15 in parallel with each other. Each of the photosensors 8 (8a, 8b, 8c) is connected to the semiconductor chip 11 by way of a sensor wire 25 shown in FIGS. 1 and 4. For the liquid crystal display panel 1 viewed in a plan view, the sensor wires 25 are disposed on the outside of the first wire 21a, the second wire 24a, and the image line 22.

Referring to FIG. 2, the backlight 7 is disposed on an underside of the first substrate 2. External light 13 is incident on the second substrate 3 from an upward direction, while backlight light 14 is incident on the first substrate 2 from a downwardly direction.

A light shielding film 6 is disposed on a backside of the first substrate 2 at an area overlapping the photosensor 8 in a planar direction. This arrangement allows the photosensor 8 to detect the illuminance of the external light 13 accurately without being affected by the backlight light 14.

Functions achieved by using the photosensor 8 will be described below.

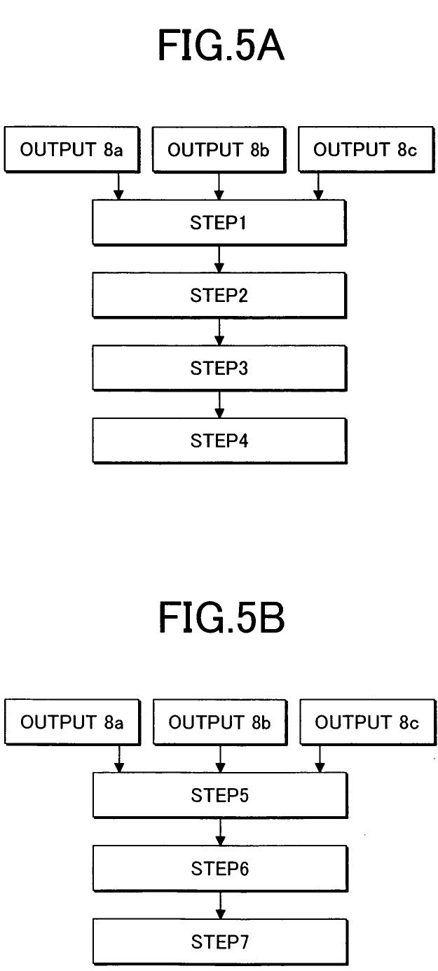

FIG. 5A is a flowchart showing typical procedures for adjusting the luminance of the backlight 7 of the liquid crystal display panel 1 according to the embodiment of the present invention.

A circuit achieving the luminance adjustment function for the backlight 7 in the semiconductor chip 11 adjusts the luminance of the backlight 7 by following the procedures shown in FIG. 5A based on a current value outputted from the photosensor 8.

Specifically, current (photocurrent ip) flows when external light enters a channel section of the photosensor 8. The current is converted to a corresponding digital value by an A/D converter (step 1). Then, with reference to an adjusted light value table, which stores beforehand a relationship between current values and adjusted light values, an adjusted light value corresponding to the digital value calculated in step 1 is selected (step 2). The adjusted light value selected in step 2 is fed back to an LED regulator (step 3). The backlight 7 is adjusted according to the adjusted light value fed back in step 3 (step 4).

To achieve the luminance adjustment function for the backlight 7 according to the embodiment of the present invention, either of the following two ways may be taken. Specifically, the luminance of the backlight 7 is adjusted based on an average value of the photocurrent ip detected by each of the three photosensors 8 (8a, 8b, 8c), or based on an average value of two larger values of the photocurrent ip out of the three values of the photocurrent ip detected by the three photosensors 8 (8a, 8b, 8c).

The latter case allows both the touch sensor function of the semiconductor chip 11 to be described later and the luminance adjustment function for the backlight 7 to be carried out simultaneously.

Light adjustment for the backlight 7 is accomplished as follows. The luminance of the backlight 7 is raised with dark ambient illuminance and is lowered with bright ambient illuminance.

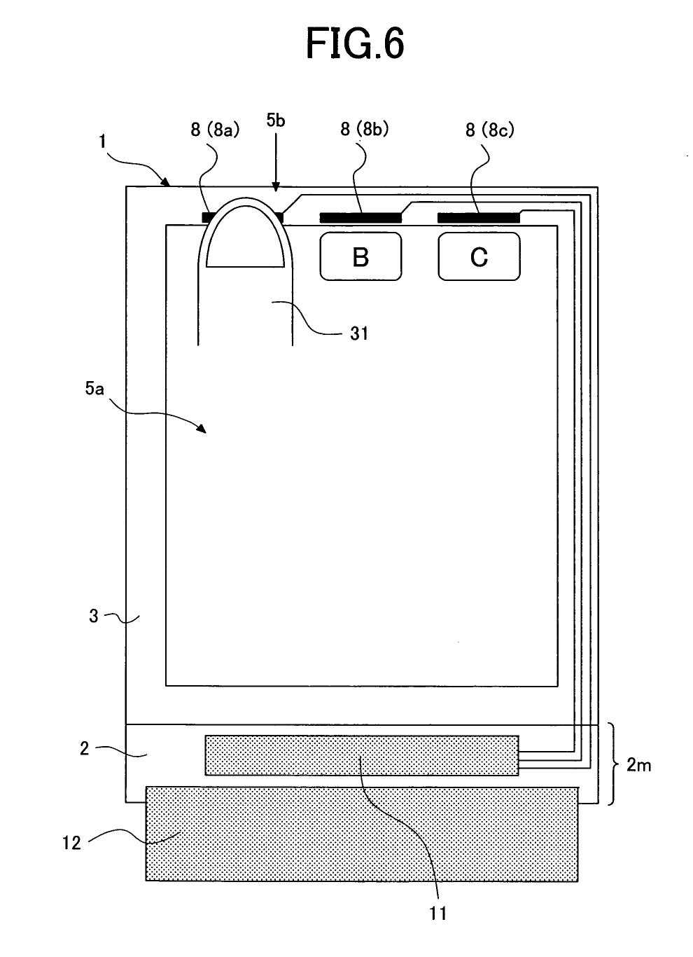

FIG. 6 is a view showing an example of a condition, in which a viewer touches the display section 5a of the liquid crystal display panel 1 with his or her finger in the liquid crystal display module according to the embodiment of the present invention.

The circuit in the semiconductor chip 11 for achieving the touch sensor function detects a specific position in the display section 5a of the liquid crystal display panel 1, at which the viewer's finger touches.

In FIG. 1, the display section 5a of the liquid crystal display panel 1 shows three menu buttons (A, B, C) in association with the three photosensors 8 (8a, 8b, 8c), respectively.

The three photosensors 8 (8a, 8b, 8c) are disposed at respective positions near the menu buttons (A, B, C) and covered by the viewer's finger when the viewer touches with his or her finger the menu buttons (A, B, C).

As a result, when the viewer's finger touches any one of the three menu buttons (A, B, C) shown on the display section 5a of the liquid crystal display panel 1, the finger then covers a corresponding photosensor (e.g., 8a) in the menu screen.

This makes the current value detected by the photosensor 8a smaller than those detected by the two other photosensors (8b, 8c). The specific position at which the viewer's finger touches is detected based on this difference in current values.

More specifically, the three menu buttons (A, B, C) are displayed on the display section 5a of the liquid crystal display panel 1 in association with the three photosensors 8 (8a, 8b, 8c). Referring to FIG. 6, if, for example, a viewer's finger 31 touches a menu button A displayed on the display section 5a of the liquid crystal display panel 1 so as to cover the photosensor 8a, only the current value of the photosensor 8a covered by the viewer's finger becomes small.

FIG. 5B is a flowchart showing typical procedures for position detection when the viewer's finger 31 touches the display section 5a of the liquid crystal display panel 1 according to the embodiment of the present invention.

A current value detected by the photosensor 8a and current values detected by the two other photosensors 8b, 8c are converted to corresponding digital values by the A/D converter (step 5). The current values detected in step 5 are compared with each other (step 6). If the difference between the current value detected by the photosensor 8a and the current values detected by the two other photosensors 8b, 8c equals to, or more than, a predetermined value, it is then determined that the viewer's finger 31 touches the menu button A (step 7).

As described heretofore, according to the embodiment of the present invention, the photosensors for controlling the luminance of the backlight are used also as the touch sensors. This makes it possible to provide a liquid crystal display module having a touch function, offering outstanding low cost performance without allowing light transmissivity to be reduced. Various applications to which the present invention is applied are conceivable. As an example, the functions as the brightness adjustment sensor and the touch sensor can both be achieved if the photosensor is normally configured to perform the function of the touch sensor and, at predetermined regular intervals, perform the function of making a backlight brightness adjustment (operations performed according to FIG. 5A).

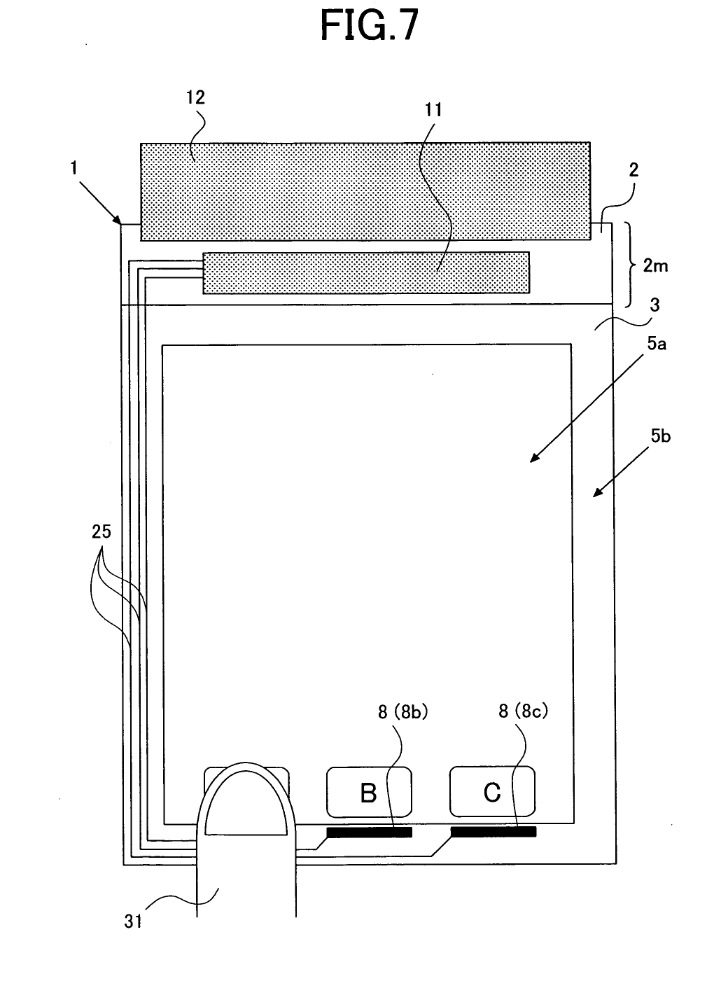

FIG. 7 is a view showing another example of the condition, in which the viewer touches the display section 5a of the liquid crystal display panel 1 with his or her finger in the liquid crystal display module according to the embodiment of the present invention.

FIG. 6 shows a condition, in which the liquid crystal display module according to the embodiment of the present invention is mounted inside housing of a mobile phone such that the photosensors 8 (8a, 8b, 8c) are disposed on the side of fingertips of the viewer. FIG. 7, on the other hand, shows a condition, in which the liquid crystal display module according to the embodiment of the present invention is mounted inside the housing of the mobile phone such that the photosensors 8 (8a, 8b, 8c) are disposed on the side of a wrist of the viewer.

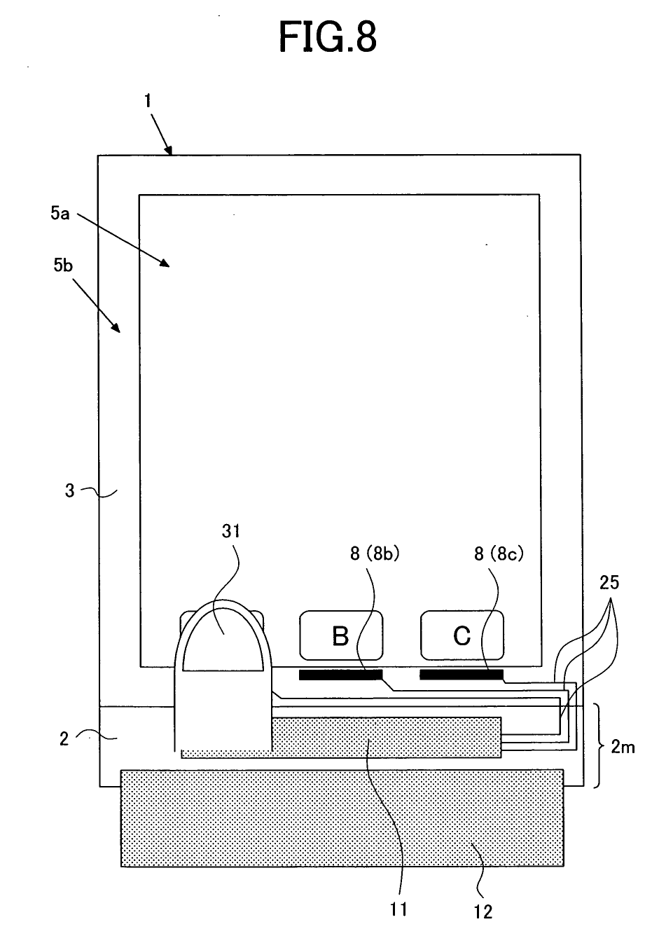

FIG. 8 is a view showing another example of the condition, in which the viewer touches the display section 5a of the liquid crystal display panel 1 with his or her finger in a liquid crystal display module according to a modified example of the embodiment of the present invention.

FIG. 6 shows a condition, in which the photosensors 8 (8a, 8b, 8c) are disposed on the first substrate 2 on a side opposite the semiconductor chip 11 of the display section 5a of liquid crystal display panel 1. FIG. 8, on the other hand, shows a condition, in which the photosensors 8 (8a, 8b, 8c) are disposed on the first substrate 2 on the same side as the semiconductor chip 11 of the display section 5a of liquid crystal display panel 1.

The arrangements shown in FIGS. 7 and 8 can also achieve the operations and effects described earlier.

In the arrangement described above, the circuit achieving the touch sensor function (the means 1 of the present invention) and the circuit achieving the luminance adjustment function for the backlight 7 (the means 2 of the present invention) are disposed in the semiconductor chip 11. It is nonetheless possible to dispose either the circuit achieving the touch sensor function (the means 1 of the present invention) or the circuit achieving the luminance adjustment function for the backlight 7 (the means 2 of the present invention), or both, in an MPU on a main unit side (main unit of the mobile phone in the foregoing embodiment).

A sensor structure of the photosensor well adapted for use in the embodiment of the present invention will be described below.

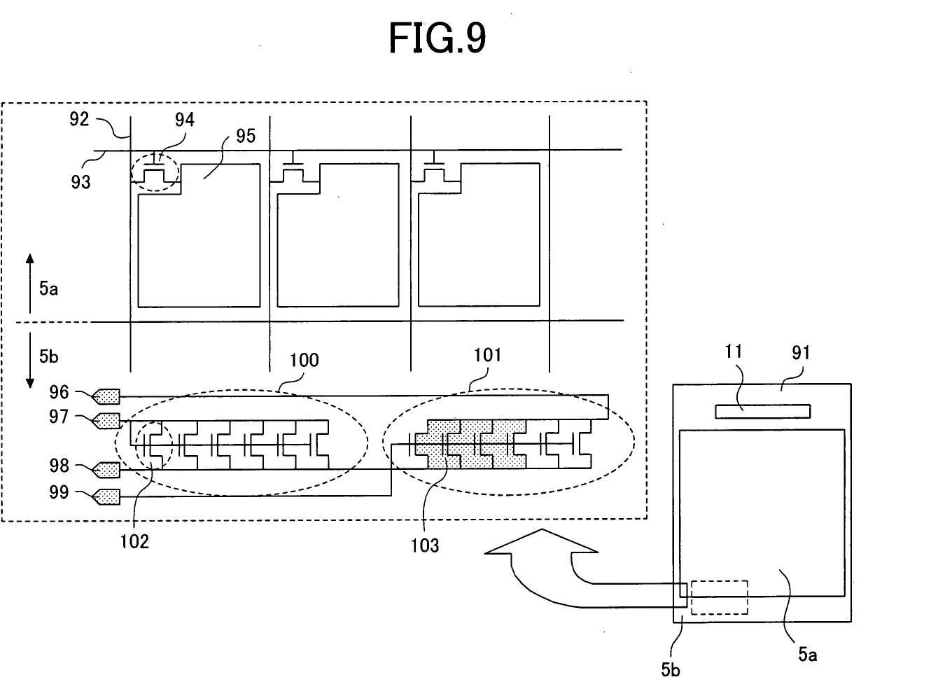

Shown on the right in FIG. 9 is a condition, in which the display section 5a, the peripheral section 5b, and the semiconductor chip 11 are disposed on a TFT substrate 91. Shown on the left in FIG. 9 is an enlarged view of a boundary portion between the display section 5a and the peripheral section 5b, enclosed by a dotted line in the figure on the right.

Referring to FIG. 9, the display section 5a is disposed so that a plurality of signal lines 92 and a plurality of scanning lines 93 cross each other by way of an insulating film. A pixel is formed so as to be associated with an area defined by each of the plurality of signal lines 92 and the plurality of scanning lines 93. Each pixel includes a pixel transistor 94 and a pixel electrode 95 connected to the pixel transistor 94.

The peripheral section 5b includes a power source voltage line 96, a GND line 97, a photo current line 98, and a reference voltage line 99.

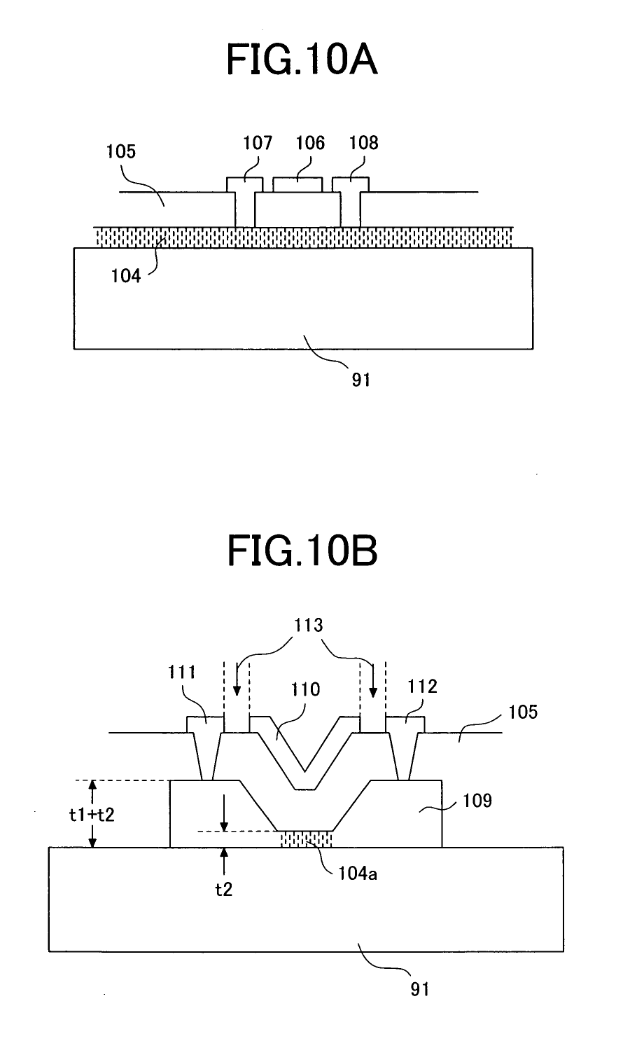

A thin film transistor structure constituting the pixel transistor 94 and a photosensor 102 in FIG. 9 will be described below with reference to FIGS. 10A and 10B, 11, and 12A through 12F.

FIG. 10A is a view showing a cross-sectional structure of the pixel transistor 94 in the display section 5a. Referring to FIG. 10A, the pixel transistor 94 is formed as follows. Specifically, a polysilicon layer 104 is disposed on the TFT substrate 91; an insulating film 105 is disposed on the polysilicon layer 104; and a gate electrode 106, a source electrode 107, and a drain electrode 108 are formed on the insulating film 105, the source electrode 107 and the drain electrode 108 being connected to the polysilicon layer 104 through through holes formed in the insulating film 105.

FIG. 10B is a view showing a cross-sectional structure of the thin film transistor constituting the photosensor 102 in the peripheral section 5b. The photosensor 102 is formed as follows. Specifically, a semiconductor layer 109 created through, for example, manufacturing processes to be described later is formed on the TFT substrate 91; then disposed via the insulating film 105 on the semiconductor layer 109 are a gate electrode 110, a source electrode 111, and a drain electrode 112. The source electrode 111 and the drain electrode 112 are connected to the semiconductor layer 109 through through holes formed in the insulating film 105. The thin film transistor constituting the photosensor 102 of FIG. 10B is characterized in the film thickness and shape of the semiconductor layer 109. Referring to FIG. 10B, the semiconductor layer 109 has a recessed cross section. The semiconductor layer 109 is connected to the source electrode 111 and the drain electrode 112 at corresponding peaks of the recess. A valley of the recess is crystallized to form an LTPS layer. In addition, a portion from the peak to the valley is tapered. The photosensor structure as described above functions as a photosensor by detecting light incident from a gap between the gate electrode 110 and the source electrode 111, or between the gate electrode 110 and the drain electrode 112.

The inventor focuses his attention on the film thickness of the semiconductor layer of the thin film transistor that performs the function of the photosensor.

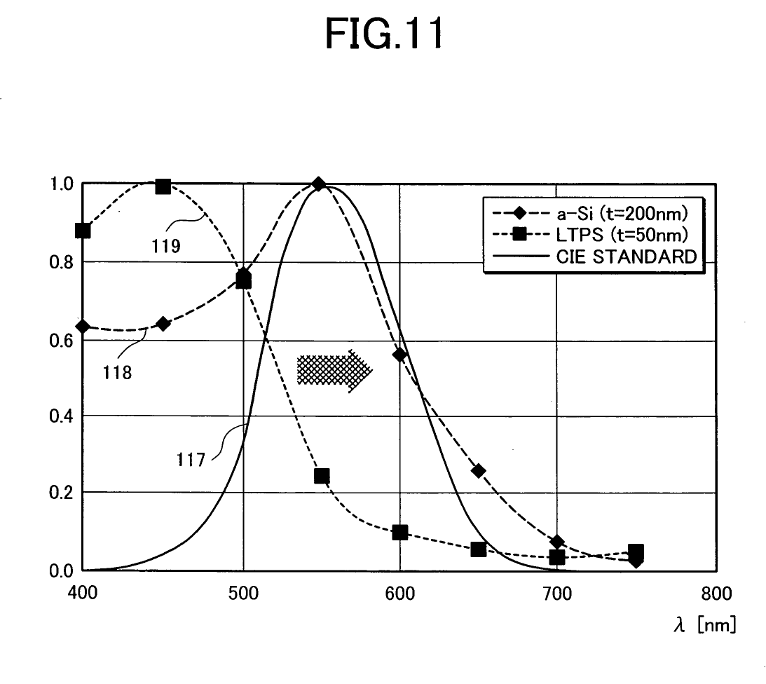

FIG. 11 is a graph indicating wavelength vs. sensitivity characteristics of the semiconductor layer, on which the abscissa represents wavelength of light (λnm) and the ordinate represents relative sensitivity.

Referring to FIG. 11, a curve 117 represents a CIE standard. A photosensor having good sensitivity can be achieved if a semiconductor layer having characteristics close to the CIE standard form is used for the semiconductor layer of the transistor performing the function of the photosensor.

A curve 118 is a plot of wavelength vs. sensitivity characteristics when a 200-nm-thick a-Si layer is used as the semiconductor layer. As is known through a comparison made between the CIE standard curve 117 and the a-Si layer plot curve 118, the CIE standard curve 117 and the a-Si layer plot curve 118 substantially coincide with each other on a side of longer wavelengths of 550 nm or more, while there is a slight deviation between the curve 117 and the curve 118 on a side with shorter wavelengths less than 550 nm.

A curve 119 is a plot of wavelength vs. sensitivity characteristics when a 50-nm-thick LTPS layer is used as the semiconductor layer.

The inventor considered that the wavelength vs. sensitivity characteristics could be controlled by the film thickness of the semiconductor layer, regardless of whether the a-Si layer or LTPS layer is used as the semiconductor layer. Specifically, the inventor considered if it was possible to bring the LTPS layer plot curve 119 to the a-Si layer plot curve 118 or even the CIE standard curve 117 by making the film thickness of the LTPS layer plot curve 119 closer to film thickness of the a-Si layer plot curve 118.

Accordingly, the inventor considered that a semiconductor layer having the characteristics close to those of the CIE standard curve 117 could be configured by making the film thickness of the LTPS layer close to 200 nm.

Meanwhile, it is known that the semiconductor layer should preferably have a film thickness of about 50 nm if the semiconductor layer is to perform the function of detecting light.

The photosensor according to-the embodiment of the present invention is therefore adapted to satisfy the foregoing requirements with arrangements made not to increase the number of manufacturing processes involved.

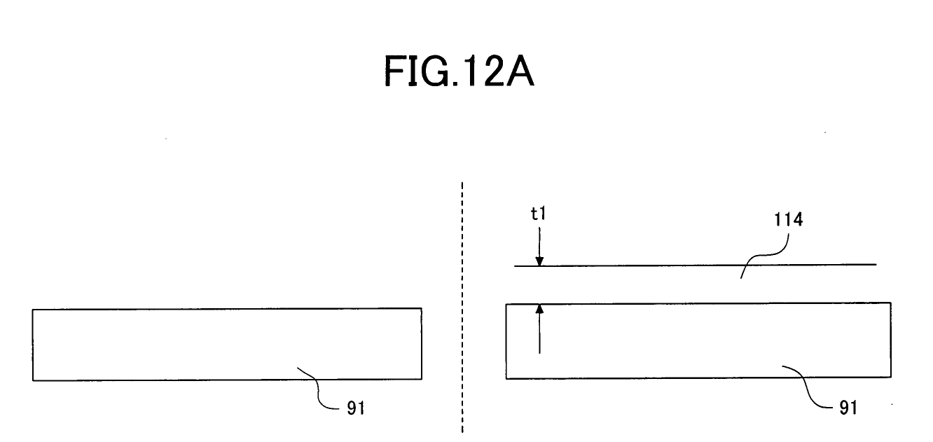

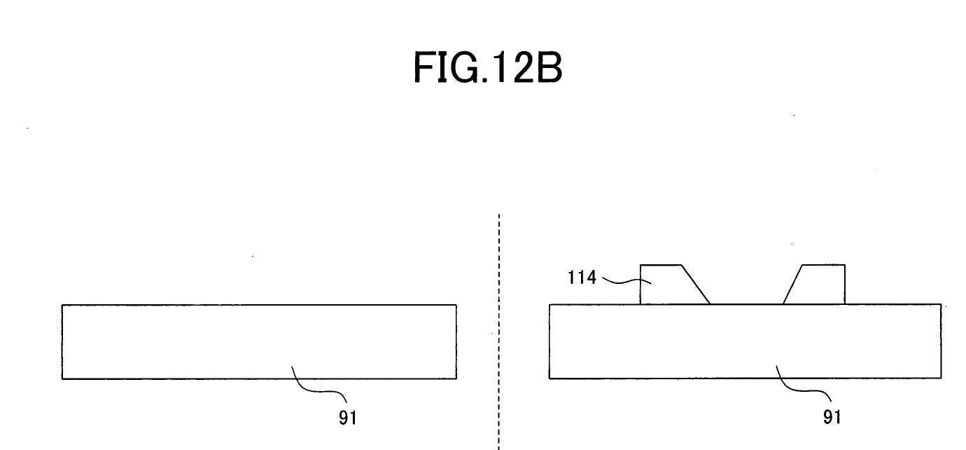

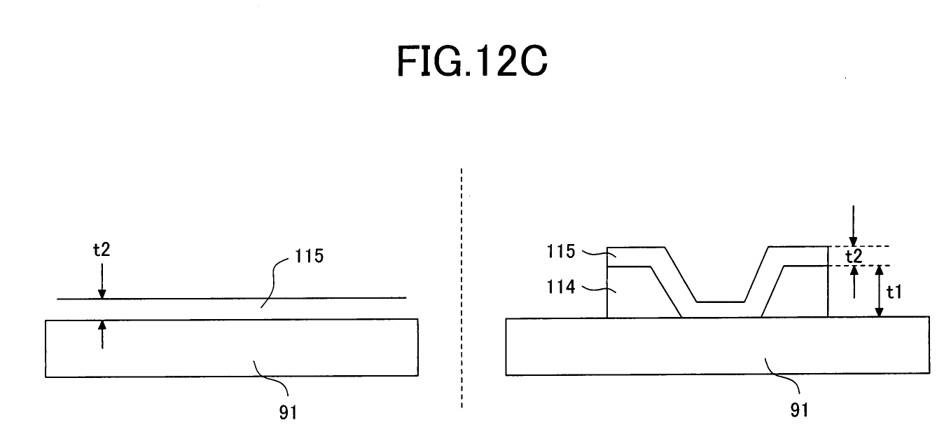

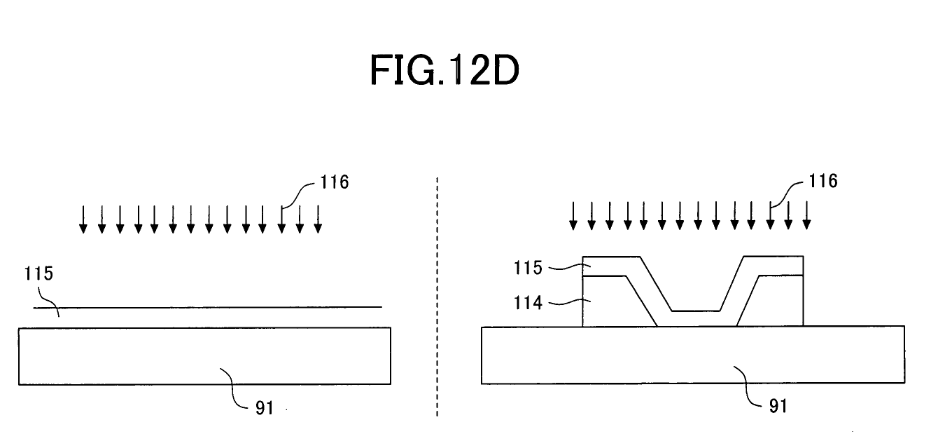

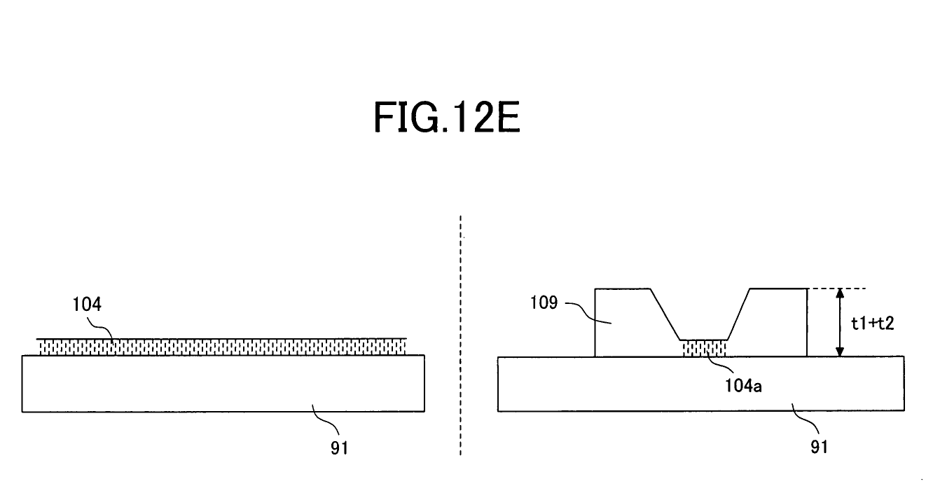

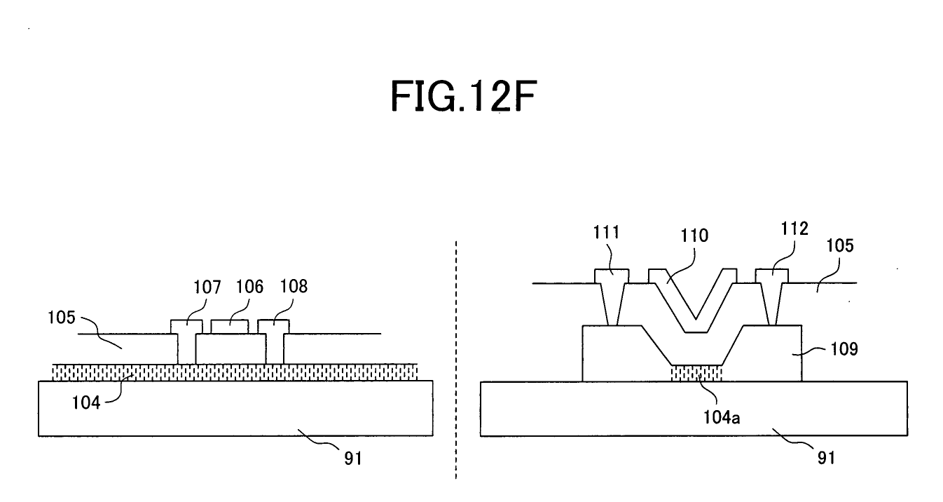

The manufacturing processes for the photosensor according to the embodiment of the present invention shown in FIG. 10B will first be described with reference to FIGS. 12A through 12F. In each of FIGS. 12A through 12F, the left-hand-side figure represents the manufacturing process for the pixel transistor of display section 5a, while the right-hand-side figure represents the manufacturing process for the photosensor of the peripheral section 5b.

FIG. 12A shows a first manufacturing process.

FIG. 12A shows that, in the first manufacturing process, a first amorphous silicon layer (first a-Si layer) 114 with a thickness of t1=150 nm is formed on the TFT substrate 91 on the photosensor side. As shown on the left-hand side of FIG. 12A, nothing is yet formed on the pixel transistor side in the first manufacturing process.

FIG. 12B shows a second manufacturing process.

FIG. 12B shows that, in the second manufacturing process, the first a-Si layer 114 disposed in the first manufacturing process is formed into a desired shape using a photo mask. As shown on the left-hand side of FIG. 12B, nothing is yet formed on the pixel transistor side in the second manufacturing process.

FIG. 12C shows a third manufacturing process.

In the third manufacturing process, a second amorphous silicon layer (second a-Si layer) 115 with a thickness of t2=50 nm is formed. The left-hand side of FIG. 12C shows that the second a-Si layer 115 is formed on the pixel transistor side. The right-hand side of FIG. 12C shows that, on the photosensor side, the second a-Si layer 115 is formed on the first a-Si layer 114 which has been formed into the desired shape in the second manufacturing process. Accordingly, an amorphous silicon layer with a thickness of 50+150=200 nm is formed on the photosensor side.

FIG. 12D shows a fourth manufacturing process.

FIG. 12D shows that a structure which has undergone the third manufacturing process is irradiated with excimer laser light 116.

FIG. 12E shows a fifth manufacturing process.

FIG. 12E shows a structure that has undergone the fourth manufacturing process. FIG. 12E shows the following conditions. Specifically, the second a-Si layer 115 on the pixel transistor side shown on the left-hand side of FIG. 12E is irradiated with excimer laser light and crystallized to become the polysilicon layer 104. On the photosensor side shown on the right-hand side of FIG. 12E, a recess 104a in the semiconductor layer 109 including the first a-Si layer 114 integrated with the second a-Si layer 115 is irradiated with the excimer laser light to become crystallized, so that a polysilicon layer is formed. It is to be noted that, in addition to the recess 104a, upper portions of the other areas of the semiconductor layer 109 are also irradiated with the excimer laser light to become crystallized. Because of the thick film thickness involved of t1+t2, which is 200 nm, the deeper the structure goes, the less the structure is crystallized. It is therefore safe to consider that a region immediately adjoining the TFT substrate 91 is only slightly crystallized or remains in the state of a-Si.

FIG. 12F shows a sixth manufacturing process.

FIG. 12F shows the following conditions. Specifically, on the pixel transistor side on the left-hand side of FIG. 12F, the insulating film 105 is formed on the polysilicon layer 104; the gate electrode 106, and the source electrode 107 and the drain electrode 108, which are connected to the polysilicon layer 104 via through holes formed in the insulating film 105, are formed on the insulating film 105 to thereby form the pixel transistor.

On the photosensor side shown on the right-hand side of FIG. 12F, the gate electrode 110, and the source electrode 111 and the drain electrode 112, are disposed by way of the insulating film 105 on the concavely shaped semiconductor layer 109. The source electrode 111 and the drain electrode 112 are connected to the semiconductor layer 109 through the through holes formed in the insulating film 105.

In the manufacturing processes shown in FIGS. 12A through 12F, the first a-Si layer 114 is adapted to have a film thickness of 150 nm and the second a-Si layer-115 is adapted to have a film thickness of 50 nm. It is considered that effects can be achieved if an arrangement is made to have a film thickness that falls within a range of ±10% of the specified film thicknesses; specifically, the film thickness of the first a-Si layer 114 falls within the range between 135 nm and 165 nm and the film thickness of the second a-Si layer 115 falls within the range between 45 nm and 55 nm. Understandably, it is considered that even better effects can be achieved if an arrangement is made to have a film thickness that falls within a range of ±5% of the specified film thicknesses; specifically, the film thickness of the first a-Si layer 114 falls within the range between 142.5 nm and 157.5 nm and the film thickness of the second a-Si layer 115 falls within the range between 47.5 nm and 52.5 nm. Further, it is considered that effects can be achieved if the concavely shaped semiconductor layer 109, which is formed by having the first a-Si layer 114 and the second a-Si layer 115 overlapping each other, is adapted to have a film thickness that falls within a range of ±10% of 200 nm at a thicker portion of the recess, specifically, a range between 180 nm and 220 nm, and a range of ±10% of 50 nm at a thinner portion of the recess, specifically, a range between 45 nm and 55 nm. Understandably, it is considered that even better effects can be achieved if the concavely shaped semiconductor layer 109 is adapted to have a film thickness that falls within a range of ±5% of 200 nm at the thicker portion of the recess, specifically, a range between 190 nm and 210 nm, and a range of ±5% of 50 nm at the thinner portion of the recess, specifically, a range between 47.5 nm and 52.5 nm.

The present invention has been described in detail with particular reference to the specific preferred embodiment thereof. It will nonetheless be understood that variations and modifications can be effected within the spirit and scope of the present invention.

What is claimed is:

1. A liquid crystal display device having a liquid crystal display panel, the liquid crystal display panel comprising:
a first substrate;
a second substrate; and
a liquid crystal layer sandwiched between the first substrate and the second substrate;
wherein the liquid crystal display panel includes a display section having a plurality of pixels disposed therein and a peripheral section disposed so as to surround the display section; and
wherein a display corresponding to a touch key is displayed on the display section at a boundary portion between the display section of the liquid crystal display panel and the peripheral section adjoining thereto, and a photosensor for detecting light is disposed at a portion in the peripheral section near the display corresponding to the touch key.

2. The liquid crystal display device according to claim 1,
wherein the photosensor produces an output of a current value detected as a result of all or part of external light being shielded when a viewer touches the display corresponding to the touch key on the display section.

3. The liquid crystal display device according to claim 1,
wherein the liquid crystal display device determines, with the photosensor, that the display corresponding to the touch key on the display section is touched when the viewer touches the display corresponding to the touch key-on the display section.

4. The liquid crystal display device according to claim 1,
wherein displays corresponding to a plurality of touch keys are displayed on the display section; and
wherein a plurality of photosensors for detecting light is disposed at locations near the displays corresponding to the plurality of touch keys.

5. The liquid crystal display device according to claim 4,
wherein each of the plurality of photosensors compares a current value detected as a result of all or part of external light being shielded when a viewer touches any of the displays corresponding to the plurality of the touch keys displayed on the display section against current values detected by other photosensors, thereby determining a specific display corresponding to a specific touch key is selected.

6. The liquid crystal display device according to claim 1, further comprising a backlight,
wherein a luminance of the backlight is adjusted based on the output of the current value produced by the photosensor.

7. The liquid crystal display device according to claim 1,
wherein the first substrate includes a non-overlapping area, in which the first substrate does not overlap the second substrate; and
wherein a driving circuit controlling the liquid crystal display panel is mounted on-the non-overlapping area of the first substrate.

8. The liquid crystal display device according to claim 4,
wherein each of the plurality of photosensors is composed of a plurality of thin film transistors connected in parallel with each other.

9. A liquid crystal display device having a liquid crystal display panel, the liquid crystal display panel comprising:
a first substrate; and
a second substrate smaller in size than the first substrate, a liquid crystal being sandwiched between the first substrate and the second substrate;
wherein a portion, on which the first substrate overlaps the second substrate, includes a display section and a peripheral section;
wherein a plurality of gate wires, and a plurality of signal wires disposed so as to intersect the plurality of gate wires by way of an insulating film, are disposed on the first substrate to form the display section; and
wherein, at a boundary portion between the display section and the peripheral section, a display corresponding to a touch key is displayed on the display section and a photosensor for detecting light is disposed on the peripheral section at a portion near the display corresponding to the touch key.

10. The liquid crystal display device according to claim 9,
wherein the photosensor produces an output of a current value detected as a result of all or part of external light being shielded when a viewer touches the display corresponding to the touch key on the display section.

11. The liquid crystal display device according to claim 9,
wherein displays corresponding to a plurality of touch keys are displayed on the display section; and
wherein a plurality of photosensors for detecting light is disposed at locations near the displays corresponding to the plurality of touch keys.

12. The liquid crystal display device according to claim 11,
wherein a driving circuit controlling the liquid crystal display panel is disposed on a portion of the first substrate, on which the first substrate does not overlap the second substrate;
wherein the displays corresponding to the plurality of touch keys are displayed on a portion of the display section opposite a side on which the driving circuit is disposed; and
wherein the plurality of photosensors is disposed on the peripheral section of the portion of the display section opposite the side on which the driving circuit is disposed.

13. The liquid crystal display device according to claim 12,
wherein the plurality of gate wires, the plurality of signal wires, and the plurality of photosensors are connected to the driving circuit; and
wherein, when the liquid crystal display panel is viewed in a planar direction, wires connecting the plurality of photosensors to the driving circuit are disposed on an outside of wires connecting the plurality of gate wires or the plurality of signal wires to the driving circuit.

14. A liquid crystal display device having a liquid crystal display panel, the liquid crystal display panel comprising:
a first substrate; and
a second substrate smaller in size than the first substrate, a liquid crystal being sandwiched between the first substrate and the second substrate;
wherein a portion, on which the first substrate overlaps the second substrate, includes a display section and a peripheral section;
wherein a plurality of gate wires, and a plurality of signal wires disposed so as to intersect the plurality of gate wires by way of an insulating film, are disposed on the first substrate to form the display section;
wherein a pixel is formed so as to be associated with an area defined by each of the plurality of gate wires and the plurality of signal wires, each pixel including a first thin film transistor switching each pixel and a pixel electrode connected to the first thin film transistor;
wherein, at a boundary portion between the display section and the peripheral section, a display corresponding to a touch key is displayed on the display section and a photosensor for detecting light is disposed on the peripheral section at a portion near the display corresponding to the touch key; and
wherein the photosensor includes a second thin film transistor.

15. The liquid crystal display device according to claim 14,
wherein the first thin film transistor includes a semiconductor layer formed of a p-Si layer; and
wherein the second thin film transistor includes a semiconductor layer having a concavely shaped cross section, the concavely shaped semiconductor layer including a thin layer portion formed of a p-Si layer.

16. The liquid crystal display device according to claim 15,
wherein the concavely shaped semiconductor layer forming the second thin film transistor includes a thick layer portion having a thickness ranging between 180 nm and 220 nm and the thin layer portion having a thickness ranging between 45 nm and 55 nm.

17. The liquid crystal display device according to claim 16,
wherein the semiconductor layer forming the first thin film transistor has a thickness ranging between 45 nm and 55 nm.

18. The liquid crystal display device according to claim 17,
wherein the second thin film transistor includes a source electrode and a drain electrode, both being connected to the thick layer portion of the concavely shaped semiconductor layer.
